(19) United States
(12) Patent Application Publication
(10) Pub. No.: US 2005/0078091 A1
(43) Pub. Date: Apr. 14, 2005

(54) Keyboard with more than one eject key, a user key and/or regional illumination

(76) Inventors: Thomas S. Neal, Cupertino, CA (US); John Norman, San Jose, CA (US); Guillermo Andres, Pleasanton, CA (US); Immanuel Jimenez Amo, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/683,327

(22) Filed: Oct. 10, 2003

(51) Int. Cl. G09G 5/00

(52) U.S. Cl. 345/168

(57) ABSTRACT

A keyboard for providing data to a processor of a computer includes two eject keys each operable to eject removable storage media from a storage device coupled with the processor, a user key operable to display a menu of user accounts that include data for identifying a user within the processor, and an illumination device to illuminate the keyboard. With the two ejects keys, one may eject removable storage media from more than one storage device without having to operate an eject key located on the storage device. With the user key, one may access a menu of user accounts without having to use a mouse or other keys of the keyboard to search for and then display a menu of user accounts. With the illumination device one may use the keyboard in a low-light environment.

The U.S. Design Patent applications entitled MULTIMEDIA KEYS FOR KEYBOARD OR SIMILAR ARTICLE, Ser. No. ______ attorney docket number 1964-48-5, and BORDER AND SPECIAL FUNCTION KEYS FOR KEYBOARD OR SIMILAR ARTICLE, Ser. No. ______ attorney docket number 1964-48-5, both filed on 10 Oct. 2003, are herein incorporated by this reference.

### BACKGROUND

Many computer systems include a processor that receives data and executes instructions, a keyboard coupled to the processor to allow one to provide data to the processor, and more than one storage device coupled to the processor to retrieve data stored on removable storage media. The keyboard typically includes a group of alphanumeric keys to provide data, and function keys to provide additional data to the processor. The function keys provide data that differs according to the application software the processor is running at the time. Thus, one may quickly and easily provide the processor data that otherwise would require one to use a mouse, and/or more than one key from the alphanumeric group of keys. The keyboard may also include an illumination device to illuminate the keyboard's keys, and thus allow one to use the computer in low-light environments.

For example, FIG. 1 shows a computer system 10 that includes a processor 12, storage devices 14 coupled with the processor 12, a conventional keyboard 16 coupled with the processor 12 via a cable 18 or wireless connection (not shown), and a monitor 20 coupled with the processor via a cable 22 to display information. The processor 12 includes circuitry, such as a central processing unit (CPU), for performing various computing functions, such as executing programs to perform specific tasks. The storage devices 14 may include a compact disc drive, such as a cdrw drive and/or a dvd drive, having an eject button 24 and that can transfer data to and from a compact disc inserted into the drive, or other types of storage devices, such as a magnetic disc or tape drive. The keyboard 16 includes a group of functional keys 26 having a single key 28 that one may use to instruct the processor 12 to eject a removable compact disc from one of the storage devices 14. The keyboard 16 also includes a group of alphanumeric keys 29.

Unfortunately, the conventional keyboard 16 does not permit one to quickly and easily perform some desirable functions. For example, the keyboard 16 does not include an additional eject key to eject a compact disc from the additional storage device 14. Consequently, when one uses both storage devices 14 at the same time, one must use the eject button 24 to eject the compact disc from one of the devices. This can be awkward when the processor 12 is located in a confined space away from the keyboard 16.

For another example, the keyboard 16 does not include a user key to display a menu of user accounts that include data for identifying a user within the processor 12. Consequently, when one wants to log off—remove his/her current identity within the processor 12—and/or log on—establish an identity within the processor 12—one has to search for and display the menu using a mouse (not shown) or the keys 26 and 29.

The keyboard 16 also includes an illumination device (not shown) inside the keyboard to illuminate the keys 26 and 29. The illumination device includes a light source to generate light, and a lens to direct the light toward the keys 26 and 29. The light source typically generates light by applying a voltage across an electro-luminescent material. Unfortunately, many electro-luminescent materials are expensive. Consequently, the cost of manufacturing the keyboard 16 can be expensive.

### SUMMARY

In one aspect of the invention, a keyboard for providing data to a processor of a computer includes two eject keys each operable to eject removable storage media from a storage device coupled with the processor. With the two eject keys, one may eject removable storage media from more than one storage device coupled with the processor without having to operate an eject key located on the storage device, which may be inconveniently located away from the keyboard. Thus, one may quickly and easily eject removable storage media from two storage devices of a computer.

In another aspect of the invention, a keyboard for providing data to a processor includes a user key operable to display a menu of user accounts that include data for identifying a user within the processor. With the user key, one may access a menu of user accounts without having to use a mouse or other keys of the keyboard to search for and then display a menu of user accounts. Thus, one may quickly and easily access a menu of user accounts to log off and/or log on as one of the users in the menu.

In yet another aspect of the invention, a keyboard includes an illumination device to illuminate the keyboard, for example a key of the keyboard or a section of the keyboard, such as a panel. The illumination device includes a light source to generate light, a lens to receive and direct the light toward the keyboard, and a diffuser to distribute the light across the keyboard or a portion of the keyboard. The light source may include a light emitting diode (LED) or any other light-emitting device. With the illumination device one may use the keyboard in low-light environments, and with an LED the cost of manufacturing the illumination device may be kept low.

### BRIEF DESCRIPTION OF THE FIGURES

FIG. 1 is a perspective view of a computer that incorporates a conventional keyboard.

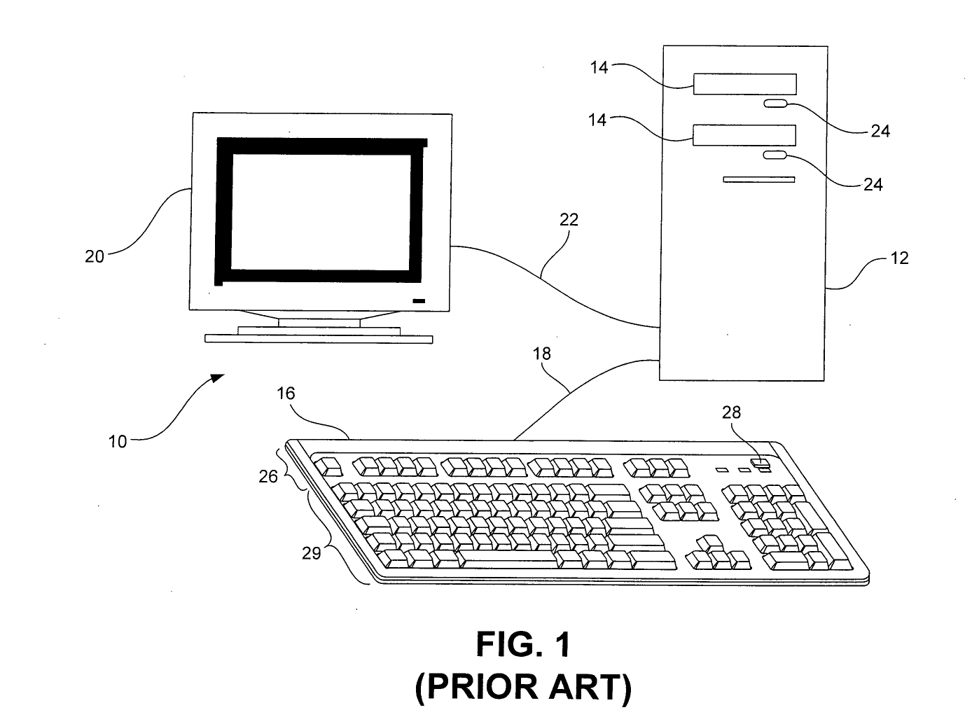

FIG. 2 is a schematic diagram of a computer incorporating a keyboard according to an embodiment of the invention.

FIG. 3 is an exploded, perspective view of the keyboard in FIG. 2.

FIG. 4 is a side view of an illumination device incorporated in the keyboard in FIG. 3.

FIG. 5 is a plan view of a lens incorporated in the illumination device of FIG. 4.

### DETAILED DESCRIPTION

The following discussion is presented to enable one skilled in the art to make and use the invention. Various modifications to the disclosed embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

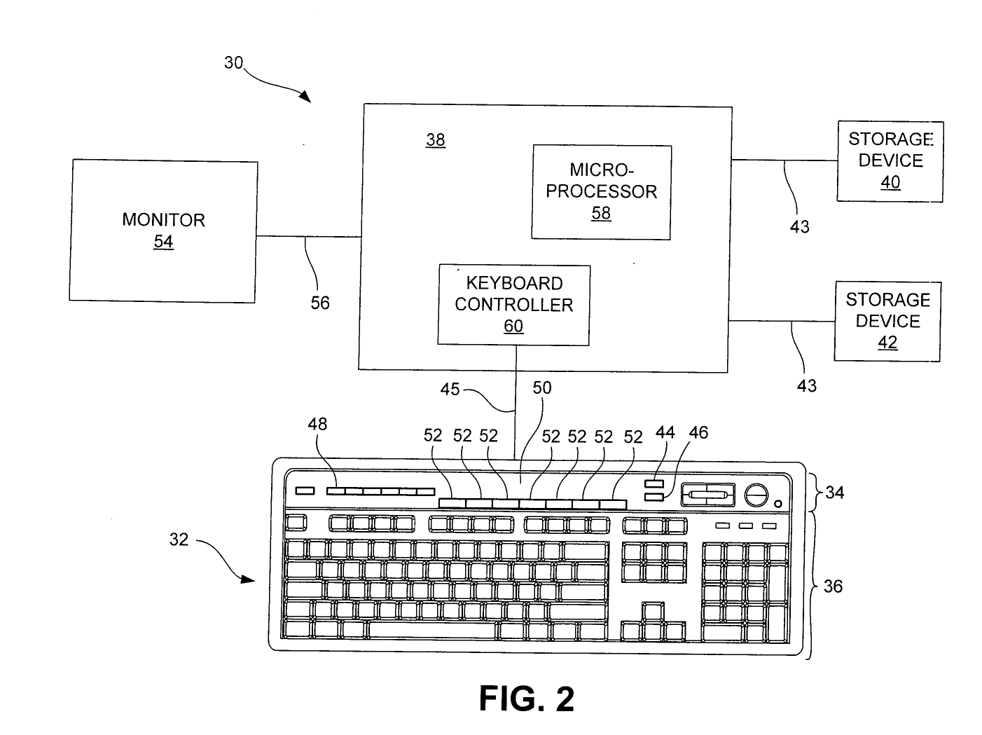

FIG. 2 is a schematic diagram of a computer system 30 that incorporates a keyboard 32 according to an embodiment of the invention. The keyboard 32 includes keys 34 that allow one to quickly and easily provide data to other components of the computer system 30, in addition to keys 36 typically included in a conventional keyboard. The computer system 30 includes a processor 38 that receives data and has circuitry for performing various computing functions, such as executing instructions. The computer system 30 also includes storage devices 40 and 42, such as compact disc drives and/or magnetic disc or tape drives, that transfer data to and from removable storage media (not shown), such as compact discs, magnetic discs and magnetic tape, respectively. The storage devices 40 and 42 are coupled with the processor 38 through cables 43, and a cable 45 couples the keyboard 32 with the processor 38; but the devices 40 and 42 and keyboard 32 may be coupled wirelessly with the processor 38. The computer system 30 may also include a monitor 54 coupled with the processor 38 via a cable 56 to display data.

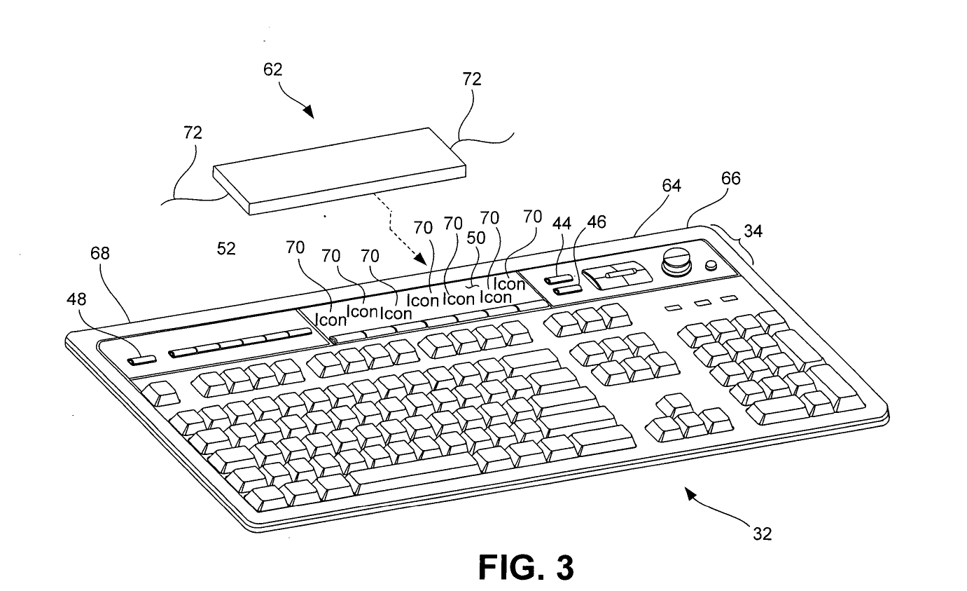

In one embodiment of the keyboard 32, the keys 34 may include eject keys 44 and 46 to eject removable storage media from the storage devices 40 and 42, and a user key 48 to display a menu (not shown) of user accounts that include data for identifying a user within the processor 38. In addition, the keyboard 32 may include and an illumination device (omitted for clarity but discussed in greater detail in conjunction with FIGS. 3, 4 and 5) to illuminate the keyboard 32. For example, the illumination device may illuminate the keys 34 and 36, and/or a section of the keyboard 32, such as a panel 50 that may include an icon (also omitted for clarity) to indicate the functionality of one or more of the keys 52. In other embodiments, the keys 34 of the keyboard 32 may include the two eject keys 44 and 46 only, the user key 48 only, the illumination device only, or any combination of these.

With the eject keys 44 and 46, one may eject removable storage media from the storage devices 40 and 42 without having to operate an eject key (not shown) located on the storage devices 40 and 42, which may be inconveniently located away from the keyboard 32. With the user key 48, one may access a menu of user accounts without having to use a mouse or other keys 36 of the keyboard 32 to search for and then display a menu of user accounts. With the illumination device, one may use the keyboard 32 in low-light environments.

Still referring to FIG. 2, the processor 38 includes a microprocessor 58 to execute instructions included in software that the microprocessor 58 runs, and a keyboard controller 60 to receive data from the keyboard 32 and direct the data toward keyboard software that the microprocessor 58 runs. With the data from the keyboard controller 60, the keyboard software instructs the microprocessor 58 to perform a task. To provide data to the keyboard software that the keyboard software can utilize, the keyboard controller 60 may convert the data from the keyboard 32 and/or generate additional data

Still referring to FIG. 2, in one embodiment the eject key 44 may be used to eject removable storage media from the storage device 40, and the eject key 46 may be used to eject removable storage media from the storage device 42. When one pushes the eject key 44, the keyboard controller 60 receives data from the keyboard 32 and converts the data into data that the keyboard software can utilize. The keyboard software then instructs the microprocessor 58 to direct the storage device 40 to eject the removable storage media. When one pushes the eject key 46, the keyboard controller 60 receives data from the keyboard 32 and converts the data into data that the keyboard software can utilize. The keyboard software then instructs the microprocessor 58 to direct the storage device 42 to eject the removable storage media. Consequently, one may avoid using an eject key (not shown) located on the storage devices 40 and 42 to eject removable storage media from the storage devices 40 and 42.

Other embodiments are contemplated. For example, the keyboard 32 may include more than two eject keys, which may be more or fewer than the number of storage devices coupled with the processor 38. If the keyboard 32 includes more eject keys than storage devices included in the computer system 30, the additional eject keys may be used to eject removable storage media from one storage device. For example, if the computer system 30 includes one storage device 40 and the keyboard 32 includes two eject keys 44 and 46, both eject keys 44 and 46 may be used to eject removable storage media from the storage device 40. If the keyboard 32 includes fewer eject keys than storage devices included in the computer system 30, the eject keys may be used to eject removable storage media from some but not all of the storage devices.

Still referring to FIG. 2, the keyboard software may associate the eject keys 44 and 46 with the storage devices 40 and 42 as desired. In one embodiment, for example, the keyboard software may associate the eject key 44 only with the storage device 40, and the eject key 46 only with the storage device 42. Thus, to eject removable storage media from the storage device 40, one must push the eject key 44.

In another embodiment, the keyboard software may include instructions to monitor which storage device is used first and then to associate the eject key 44 with that storage device. Thus, if one initially uses the storage device 42, the keyboard software may associate the eject key 44 with the storage device 40.

Still referring to FIG. 2, the keyboard 32 includes the user key 48 that one may use to quickly and easily display a menu of user accounts that include data for identifying a user account within the processor 38. For example, in one embodiment, one may push the user key 48 to display a menu of user accounts on the monitor 54. With a menu of user accounts displayed, one may provide data to user account software, typically included in the processor's operating system software, to remove the currently existing user identity from the processor 38 or establish a user identity. When one pushes the user key 48, the keyboard controller 60 receives data from the keyboard 32 and converts the data into data that the keyboard software can utilize. The keyboard software then sends data to the operating system software. The operating system software then displays the menu of user accounts on the monitor 54. Thus, one may access a menu of user accounts by pushing a single key.

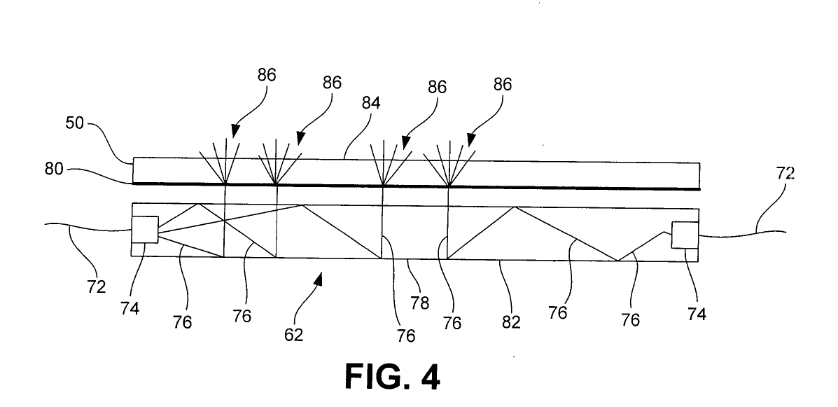

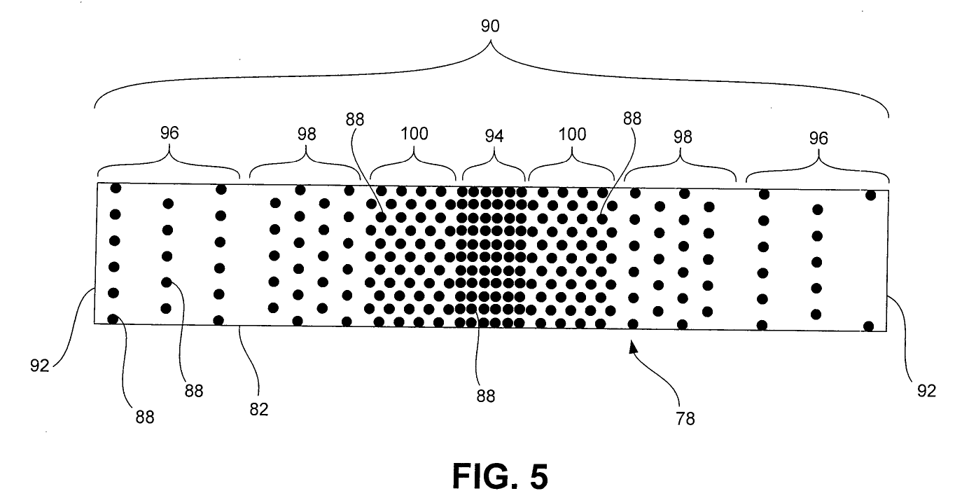

FIG. 3 is an exploded, perspective view of the keyboard 32 in FIG. 2. The keyboard 32 includes an illumination device 62 to illuminate the panel 50 (discussed in greater detail in conjunction with FIGS. 4 and 5) and thus allow one to use the keyboard 32 in a low-light environment. The illumination device 62 is typically located inside the keyboard 32, underneath the panel 50, to backlight the panel 50, but may be located anywhere desired to illuminate the panel or other sections of the keyboard 32. The keyboard 32 or a section of the keyboard 32 may also be illuminated by other illumination devices, such as those discussed in U.S. Pat. Nos. 6,217,183 and 6,467,924, both issued to Shipman and both entitled KEYBOARD HAVING ILLUMINATED KEYS, which are incorporated herein by this reference.

Referring to FIG. 3, the keys 34 and panel 50 may be located anywhere on the keyboard 32, and the panel 50 may include an icon to indicate the functionality of one or more of the keys 52. In one embodiment, for example, the eject keys 44 and 46 may be located in a right half 64 of a top portion 66 of the keyboard 32, and the user key 48 may be located in a left half 68 of the top portion 64. The panel 50 may include seven icons 70 that respectively correspond to seven keys 52. The icons 70 may be translucent or transparent and may include text, pictorial representations or a combination of the two to indicate the functionality of a corresponding key 52. For example, one of the keys 52 may be used to display an email application program on the monitor 54 (FIG. 2) and the corresponding icon 70 may include the text “e-mail” and a pictorial representation of a sealed envelope. When one uses the keyboard 32 in a low-light environment, power may be provided to the illumination device 62 via the cables 72 to project light through the icons 70 on the panel 50. With the icons 70 illuminated, one may easily and quickly identify the functionality of the keys 52 the icons 70 correspond with.

Other embodiments are contemplated. For example, the eject keys 44 and 46, and the user key 48 may be located in a bottom portion of the keyboard 32. In addition, the icons 70 may be opaque and the remaining portion of the panel may be translucent or transparent to allow one to read the shadow of the icons 70 in a low-light environment.

FIG. 4 is a side view of the illumination device 62 in FIG. 3. The illumination device 62 includes a light source 74 to generate light (illustrated as rays 76), a lens 78 to receive and direct the light 76 toward the panel 50, and a diffuser 80 to distribute the light 76 from the lens 78 across the panel 50. To direct the light 76 toward the panel 50, the lens 74 includes reflective regions (not shown but discussed in greater detail in conjunction with FIG. 5) to reflect the light 76 in the lens 74 toward the panel 50.

In one embodiment of the illuminating device 62, the light source 74 may include two light emitting diodes (LED's) located at opposite ends of the lens 78 and supplied with power via the cables 72. By using LEDs, the amount of power consumed by the illuminating device 62 and the cost of manufacturing the illuminating device 62 are kept low. When powered, the LEDs generate and project light 76 toward each other into the lens 78. The lens 78 may be made of an acrylic plastic or any conventional transparent or translucent material to allow the light to travel in the lens 78 until the light encounters a reflective region located in the bottom 82 of the lens 78. The reflective region reflects the light 76 toward the diffuser 80 and out of the lens 78. The diffuser 80 may be a semi-transparent ink or any conventional translucent or semi-transparent material to diffuse the light 76 received from the reflective regions. Furthermore, the diffuser 80 may be located on the panel 50 between the lens 78 and the panel 50, or anywhere between the reflective regions and the top surface 84 of the panel 50. The diffused light 86 then travels through the panel 50 to illuminate the panel 50. By diffusing the light 76 from the lens 78, the intensity of the light 86 projected through the panel 50 is more consistent across the panel 50.

Other embodiments of the illuminating device 62 are contemplated. For example, the light source 74 may include conventional electro-luminescent material and may be located in other regions of the lens 78. In addition, the diffuser may be located on the lens 78 and may diffuse the light 76 as the light 76 leaves the lens 78.

FIG. 5 is a plan view of the lens 78 in FIG. 4 and shows the reflective regions 88 of the lens 78. The reflective regions 88, only a few of which are labeled for clarity, reflect light 76 (FIG. 4) in the lens 78 (FIG. 4) toward the panel 50 (FIG. 4) to illuminate the panel 50. The reflective regions 88 are dispersed across the lens' bottom 82 to project light from the lens 78 that is substantially uniform in intensity.

The distribution of the reflective regions 88 depends on the location of the light source 74 (FIG. 4) and the reflective efficiency of each reflective region 88, and may form a pattern on the bottom 82 of the lens 78. In one embodiment, for example, each reflective region 88 may be a circular dot painted with conventional reflective paint having substantially the same reflective efficiency, and the distribution of the reflective regions 88 may form the pattern 90. Because the light source 74 includes two LEDs located at opposite ends 92 of the lens 78, the intensity of the light in the lens 78 is high near the ends 92 and decreases the further away the light is from the ends 92. Thus, the pattern 90 may include a zone 94 having many reflective regions 88, zones 96 having few reflective regions 88, and zones 98 and 100 having more reflective regions 88 than the zones 96 have but less than the zone 94.

Other embodiments are contemplated. For example, the reflective regions 88 may be dispersed throughout the lens 78; not just on the bottom 82. In addition, each reflective region 88 may not have substantially the same reflective efficiency and may be square or any other desired shape.

Even though various embodiments of the present invention have been set forth in the foregoing description, the above disclosure is illustrative only, and changes may be made in detail and yet remain within the broad principles of the present invention. One skilled in the art will appreciate that the example embodiments described above do not limit the scope of the present invention, and will also understand various modifications, equivalents, and combination of such embodiments are within the scope of the present invention. Therefore, the present invention is to be limited only by the appended claims.

1. A keyboard for providing data to a processor of a computer, the keyboard comprising:
two eject keys each operable to eject removable storage media from a storage device coupled with the processor.

2. The keyboard of claim 1 wherein each eject key is operable to eject removable storage media from one storage device coupled with the processor.

3. The keyboard of claim 1 wherein:
a first eject key is operable to eject removable storage media from a first storage device coupled with the processor; and
a second eject key is operable to eject removable storage media from a second storage device coupled with the processor.

4. The keyboard of claim 1 wherein the two eject keys are located in a top portion of the keyboard.

5. The keyboard of claim 1 wherein the two eject keys are located in a right half of a top portion of the keyboard.

6. The keyboard of claim 1 wherein the two eject keys are located next to each other.

7. A computer system comprising:
a processor;
a storage device coupled with the processor; and
a keyboard operable to provide the processor data, and including two eject keys each operable to eject removable storage media from the storage device.

8. The computer system of claim 7 wherein the computer includes:
a first storage device and a second storage device,
a first eject key operable to eject removable storage media from the first storage device, and
a second eject key operable to eject removable storage media from the second storage device.

9. The computer system of claim 7 wherein the storage device includes a compact disc player.

10. The computer system of claim 7 wherein the storage device includes a digital video disc player.

11. A keyboard for providing data to a processor of a computer, the keyboard comprising:
a user key operable to display a menu of user accounts that include data for identifying a user within the processor.

12. The keyboard of claim 11 wherein the user key is not operable to select a user account from the menu.

13. The keyboard of claim 11 wherein the user key is located in a top portion of the keyboard.

14. The keyboard of claim 11 wherein the user key is located in a left half of a top portion of the keyboard.

15. A computer system comprising:
a processor;
a monitor coupled with the processor and operable to display data; and
a keyboard to provide data to the processor and including a user key operable to display a menu of user accounts that include data for identifying a user within the processor.

16. The computer system of claim 15 wherein the data includes permission to access other data in the computer.

17. A keyboard for providing data to a processor of a computer, the keyboard comprising:
a user key operable to display a menu of user accounts that include data for identifying a user within the processor; and
two eject keys each operable to eject removable storage media from a storage device coupled with the processor.

18. A computer system comprising:
a processor;
a monitor coupled with the processor and operable to display data;
a storage device coupled with the processor; and
a keyboard to provide data to the processor and including:
a user key operable to display a menu of user accounts that include data for identifying a user within the processor, and
two eject keys, each operable to eject removable storage media from the storage device.

19. A method for ejecting removable storage media from a storage device coupled with a processor, the method comprising:
activating one of two eject keys of a keyboard coupled with the processor; and
ejecting the removable storage media responsive to the one of the two eject keys being activated.

20. The method of claim 19 wherein activating the key includes exerting pressure to depress the key relative to the other key.

21. A method for ejecting removable media from two storage devices each coupled with a processor, the method comprising:
moving a first eject key of a keyboard coupled with the processor to eject removable storage media from a first storage device; and
moving a second eject key of the keyboard to eject removable storage media from a second storage device.

22. The method of claim 21 wherein moving each key includes exerting pressure to depress the key relative to the other key.

23. A method for displaying a menu of user accounts that include data for identifying a user within a processor, the method comprising:
moving a user key of a keyboard coupled with the processor.

24. The method of claim 23 wherein moving the key includes exerting pressure to depress the key.
